(19) United States
(12) Patent Application Publication
(10) Pub. No.: US 2026/0254107 A1
(43) Pub. Date: Aug. 27, 2026

(54) ANTENNA DEVICE AND WIRELESS DEVICE

(71) Applicant: SONY GROUP CORPORATION, Tokyo (JP)

(72) Inventor: Tomoo KOBAYASHI, Tokyo (JP)

(21) Appl. No.: 18/870,717

(22) PCT Filed: May 25, 2023
(86) PCT No.: PCT/JP2023/019561

§ 371 Date: Dec. 2, 2024

(30) Foreign Application Priority Data
Jun. 7, 2022 (JP) 2022-092518

(51) Int. Cl. H01Q 1/52; H01Q 1/22

(52) U.S. Cl. CPC H01Q 1/521; H01Q 1/22

(57) ABSTRACT

An antenna device of the present disclosure includes a first antenna and a second antenna. The first antenna is provided on one side of a ground, and has a length shorter than one wavelength of an operating frequency. The second antenna, provided on the one side, is an antenna different from the first antenna.

### FIELD

The present disclosure relates to an antenna device and a wireless device.

### BACKGROUND

In recent years, a technology of using a plurality of antennas in a wireless device such as a smartphone has been spreading. The plurality of antennas is each used, for example, for transmission and reception of a signal of mutually different frequencies. Alternatively, for example, when a plurality of antennas is used for Multi Input Multi Output (MIMO) communication, signals in the same frequency band are simultaneously transmitted or received by the plurality of antennas.

When a plurality of antennas is used for communication like this, isolation between the plurality of antennas needs to be ensured. In order to ensure isolation between a plurality of antennas, a known method increases a distance between the antennas. Alternatively, another known method locates the polarization of each antenna orthogonal to each other or inverses the direction of rotation of the circularly polarized wave.

The method of ensuring isolation by using a layout of the antenna, etc., has a problem of restricting the position of the antenna, the size of the antenna, and the like. To overcome this and in order to ensure isolation between a first antenna and a second antenna, for example, there is a known technique in which the first antenna is formed with a monopole antenna and a loop antenna branched from the monopole antenna (for example, Patent Literature 1).

### CITATION LIST

### Patent Literature

Patent Literature 1: WO 2017/069181 A

### SUMMARY

### Technical Problem

As described above, in the antenna device of the known technology, the first antenna is formed with a monopole antenna and a loop antenna. This leads to a problem that the antenna device of the know technology has a large number of elements, making it difficult to miniaturize the antenna device.

In view of this, the present disclosure provides an antenna device and a wireless device capable of further miniaturization the antenna device while ensuring isolation between antennas.

Note that the above problem or target is merely one of a plurality of problems or targets that can be solved or achieved by a plurality of embodiments disclosed in the present specification.

### Solution to Problem

An antenna device of the present disclosure includes a first antenna and a second antenna. The first antenna is provided on one side of a ground, and has a length shorter than one wavelength of an operating frequency. The second antenna, provided on the one side, is an antenna different from the first antenna.

### BRIEF DESCRIPTION OF DRAWINGS

FIG. 1 is a diagram illustrating an example of a schematic configuration of an antenna device according to a first embodiment of the present disclosure.

FIG. 2 is a diagram for illustrating an electric field generated in a monopole antenna.

FIG. 3 is a diagram illustrating an example of a schematic configuration of an antenna device.

FIG. 4 is a diagram illustrating an example of a schematic configuration of an antenna device.

FIG. 5 is a diagram for illustrating an example of an electric field generated in the antenna device according to the first embodiment of the present disclosure.

FIG. 6 is a diagram illustrating an example of a schematic configuration of an antenna device according to a second embodiment of the present disclosure.

FIG. 7 is a diagram illustrating an example of a schematic configuration of an antenna device according to a third embodiment of the present disclosure.

FIG. 8 is a diagram illustrating an example of a schematic configuration of an antenna device according to the third embodiment of the present disclosure.

FIG. 9 is a diagram illustrating an example of a schematic configuration of an antenna device according to the third embodiment of the present disclosure.

FIG. 10 is a diagram illustrating an example of a schematic configuration of a wireless device according to a fourth embodiment of the present disclosure.

FIG. 11 is a diagram illustrating an example of a schematic configuration of a wireless device according to a fifth embodiment of the present disclosure.

FIG. 12 is a diagram illustrating an example of a schematic configuration of a wireless device.

FIG. 13 is a diagram illustrating a use example of the wireless device according to the fifth embodiment of the present disclosure.

FIG. 14 is a diagram illustrating an example of a schematic configuration of a wireless device according to a sixth embodiment of the present disclosure.

FIG. 15 is a diagram illustrating an example of a schematic configuration of a wireless device.

FIG. 16 is a diagram illustrating an example of a schematic configuration of a peripheral device according to a seventh embodiment of the present disclosure.

FIG. 17 is a diagram illustrating an example of a schematic configuration of the peripheral device according to the seventh embodiment of the present disclosure.

FIG. 18 is a diagram illustrating an example of a schematic configuration of the peripheral device according to the seventh embodiment of the present disclosure.

FIG. 19 is a diagram illustrating an example of a schematic configuration of the peripheral device according to the seventh embodiment of the present disclosure.

### DESCRIPTION OF EMBODIMENTS

Hereinafter, embodiments of the present disclosure will be described in detail with reference to the accompanying drawings. In the present specification and the drawings, substantially the same elements are denoted by the same reference numerals, and redundant description will be omitted.

Furthermore, specific values, which might be used in the present specification and the drawings, are merely examples, and other values may be applied.

One or more embodiments (examples and modifications) described below can each be implemented independently. On the other hand, at least some of the multiple embodiments described below may be appropriately combined with at least some of other embodiments. The plurality of embodiments may include novel features different from each other. Accordingly, the plurality of embodiments can contribute to achieving or solving different objects or problems, and can exhibit different effects.

### 1. The First Embodiment

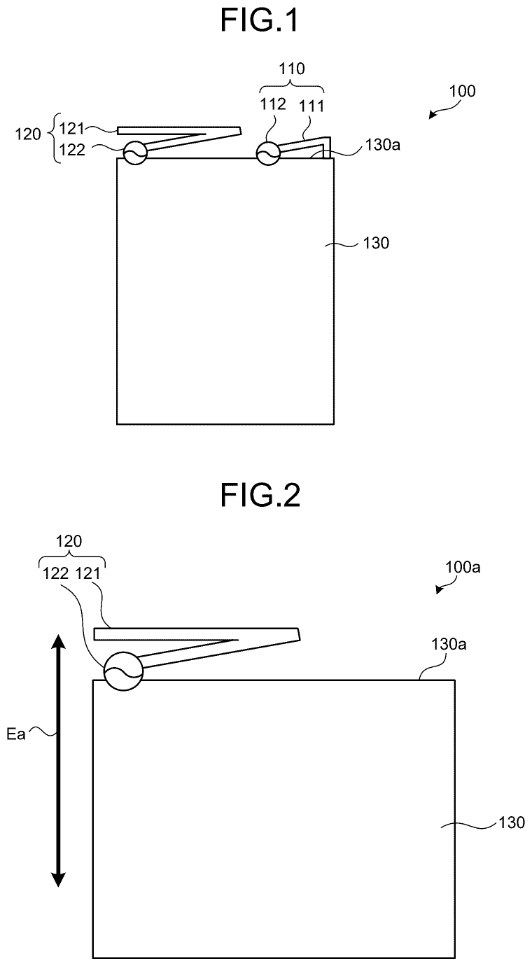

FIG. 1 is a diagram illustrating an example of a schematic configuration of an antenna device 100 according to a first embodiment of the present disclosure. The antenna device 100 illustrated in FIG. 1 includes a first antenna 110, a second antenna 120, and a ground 130.

The first antenna 110 includes a first linear element 111 and a feed point 112. Each end of the first linear element 111 is connected to a side 130a of the ground 130. Moreover, the feed point 112 is disposed at one end of the first linear element 111 on the second antenna 120 side.

Here, the first antenna 110 is an antenna referred to as a small loop antenna. That is, the length of the first antenna 110, in other words, the length of the first linear element 111 is shorter than one wavelength of an operating frequency of the first antenna 110. More specifically, the length of the first linear element 111 is approximately less than or equal to one tenth of a wavelength of the operating frequency of the first antenna 110, and is shorter than a half wavelength of the operating frequency of the first antenna 110.

In general, in a loop antenna having a length of one wavelength of an operating frequency, an antinode or a node occurs in a current flowing through the loop antenna. On the other hand, the magnitude and phase of the current flowing through the first antenna 110 being a small loop antenna are uniform.

In FIG. 1, the first linear element 111 has a shape bending at one position. That is, the first antenna 110 is a triangular small loop antenna. However, the shape of the first antenna 110 is not limited to the triangular shape. The first antenna 110 only needs to be a small loop antenna, and may have a quadrangular shape or an elliptical (or circular) shape.

The second antenna 120 includes a second linear element 121 and a feed point 122. One end of the second linear element 121 is connected to the side 130a of the ground 130. Moreover, the feed point 122 is disposed at one end of the second linear element 121.

In FIG. 1, the second linear element 121 has a shape folded back at one position. That is, the second antenna 120 is a folded monopole antenna. The number of folds of the second antenna 120 is not limited to one, and may be two or more. Alternatively, the second antenna 120 may be a non-folded monopole antenna.

The first antenna 110 and the second antenna 120 are disposed on the identical side 130a of the ground 130. In the present embodiment, even with a configuration in which the first antenna 110 and the second antenna 120 are disposed on the identical side 130a, it is possible to ensure the isolation of the first antenna 110 and the second antenna 120. This point will be described with reference to FIGS. 2 to 4.

FIG. 2 is a diagram for illustrating an electric field generated in a monopole antenna. FIG. 2 illustrates an antenna device 100a including: a second antenna 120 being a monopole antenna; and the ground 130. The antenna device 100a has the same configuration as the antenna device 100 in FIG. 1 except that the first antenna 110 is not provided.

As illustrated in FIG. 2, a current flowing through the second antenna 120 generates an electric field vibrating in a direction perpendicular to the side 130a of the ground 130 (refer to arrow Ea in FIG. 2). That is, the polarization direction of the second antenna 120 is perpendicular to the side 130a of the ground 130.

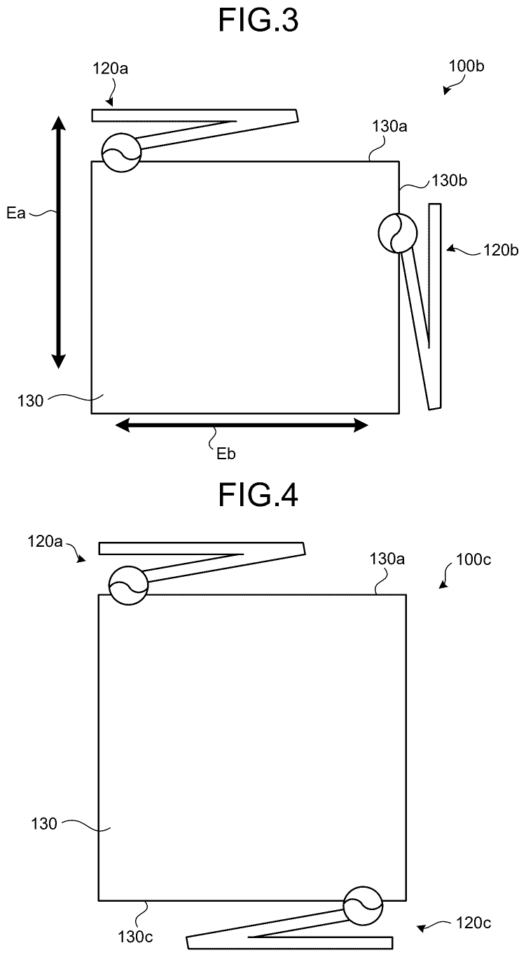

Therefore, the second antenna 120 is disposed in plurality on the ground 130, as illustrated in FIG. 3, the individual second antennas 120 are disposed to have their polarization directions orthogonal to each other. Here, FIG. 3 is a diagram illustrating an example of a schematic configuration of an antenna device 100b.

The antenna device 100b illustrated in FIG. 3 includes second antennas 120a and 120b. The second antenna 120a is disposed on a side 130a of the ground 130. The second antenna 120b is disposed on a side 130b of the ground 130. The side 130b is a side orthogonal to the side 130a.

With the second antennas 120a and 120b disposed on the orthogonal sides 130a and 130b, respectively in this manner, the polarization directions (refer to arrows Ea and Eb in FIG. 3) of the second antennas 120a and 120b are orthogonal to each other.

This makes it possible to have a low correlation in the vibration directions of the electric fields in an identical polarization plane of the second antennas 120a and 120b, successfully ensuring the isolation of the second antennas 120a and 120b.

Alternatively, it is also conceivable to ensure the isolation of the second antennas 120a and 120b by disposing the plurality of the second antennas 120a and 120b to be separated from each other. FIG. 4 is a diagram illustrating an example of a schematic configuration of an antenna device 100c.

The antenna device 100c illustrated in FIG. 4 includes second antennas 120a and 120c. The second antenna 120a is disposed on a side 130a of the ground 130. The second antenna 120c is disposed on a side 130c of the ground 130. The side 130c is a side facing the side 130a.

In this manner, with the second antennas 120a and 120c disposed on the facing sides 130a and 130c, respectively, the distance between the second antennas 120a and 120c can be increased. This makes it possible to ensure the isolation of the second antennas 120a and 120c.

However, in the antenna devices 100b and 100c described above, the second antennas 120b and 120c are respectively disposed on sides 130b and 130c different from the side 130a on which the second antenna 120a is disposed. This leads to a problem of enlargement of the antenna devices 100b and 100c.

In addition, in the case of antenna device 100c, decreasing the size of the ground 130 would shorten the distance between the second antennas 120a and 120c, having a possibility of occurrence of interference between the second antennas 120a and 120c, and thus, miniaturization is practically difficult.

In contrast, as described above, the antenna device 100 according to the embodiment of the present disclosure includes the plurality of antennas (for example, the first antenna 110 and the second antenna 120) disposed on the identical side 130a. By disposing the plurality of antennas on the identical side 130a in this manner, the antenna device 100 can be further miniaturized.

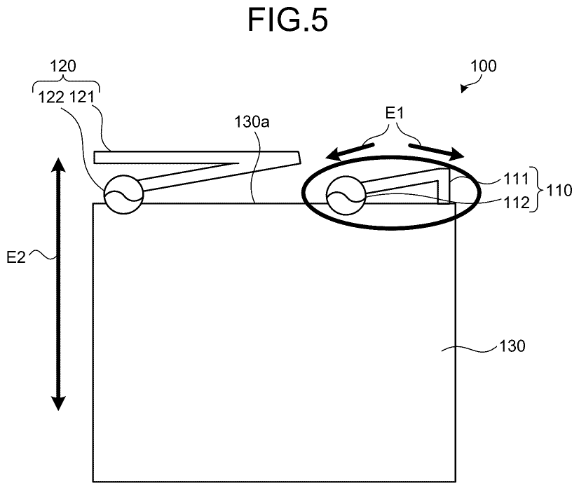

By including the first antenna 110 being a small loop antenna, the antenna device 100 can ensure the isolation of the first antenna 110 and the second antenna 120 disposed on the identical side 130a. This point will be described with reference to FIG. 5.

FIG. 5 is a diagram for illustrating an example of an electric field generated in the antenna device 100 according to the first embodiment of the present disclosure.

As described above, when a current flows through the second antenna 120, an electric field vibrating in a direction perpendicular to the side 130a (refer to arrow E2 in FIG. 5) is generated.

As described above, the current having a uniform magnitude and phase flows in the first antenna 110 along the first linear element 111 (for example, the loop shape of the first antenna 110). As illustrated in FIG. 5, the electric field generated by this current vibrates along the first linear element 111 (for example, the loop shape of the first antenna 110) (refer to arrow E1 in FIG. 5).

While the vibration direction of the electric field of the second antenna 120 is one direction, the vibration direction of the electric field of the first antenna 110 runs along the loop shape. This allows the antenna device 100 to have a decreased correlation between the vibration direction of the electric field of the second antenna 120 and the vibration direction of the electric field of the first antenna 110.

In this manner, the vibration directions of the electric fields of the first antenna 110 and the second antenna 120 have a low correlation. Therefore, even when the first antenna 110 and the second antenna 120 are disposed on identical side 130a, the antenna device 100 according to the first embodiment of the present disclosure can further reduce interference between the first antenna 110 and the second antenna 120.

The first antenna 110 and the second antenna 120 may operate in the same frequency band, or may operate in different frequencies. The antenna device 100 can ensure the isolation between the first antenna 110 and the second antenna 120 regardless of whether the operating frequency of the first antenna 110 and the operating frequency of the second antenna 120 are close or the same.

For example, the antenna device 100 can be used for MIMO communication. In this case, the antenna device 100 transmits (or receives) a same signal from the first antenna 110 and the second antenna 120 at the same frequency. In this manner, even in a case where signals of the same frequency are simultaneously transmitted (or received), since the isolation of the first antenna 110 and the second antenna 120 is ensured, the antenna device 100 can transmit (or receive) signals from the individual antennas.

When the ground 130 of the antenna device 100 has a rectangular shape, the side 130a on which the first antenna 110 and the second antenna 120 are disposed may be a short side of the ground 130.

Since the isolation between the first antenna 110 and the second antenna 120 is ensured, each of the first antenna 110 and the second antenna 120 can operate even when the length of side 130a is short. That is, the antenna device 100 according to the present embodiment can further shorten the distance between the first antenna 110 and the second antenna 120.

### 2. Second Embodiment

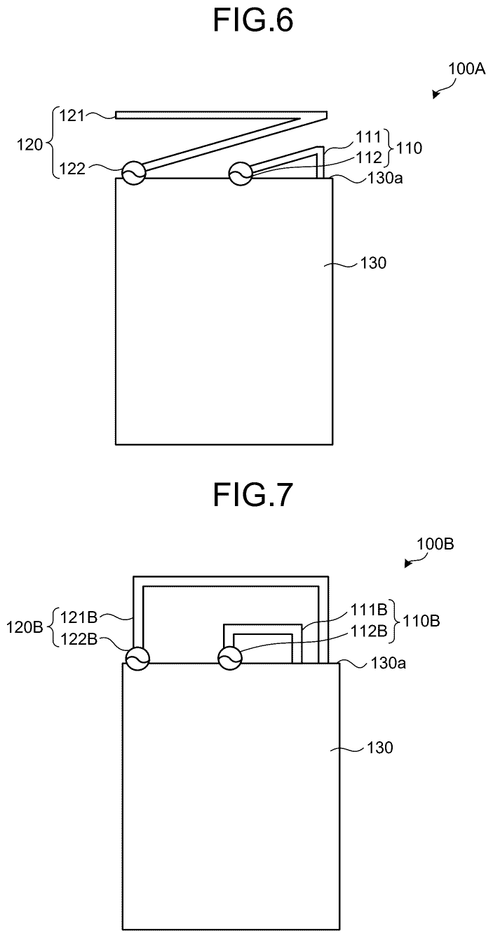

FIG. 6 is a diagram illustrating an example of a schematic configuration of an antenna device 100A according to a second embodiment of the present disclosure. The antenna device 100A in FIG. 6 differs from the antenna device 100 in FIG. 1 in the layout of the first antenna 110.

As illustrated in FIG. 6, the first antenna 110 according to the present embodiment is located between at least a part of the second antenna 120 and the side 130a of the ground 130. That is, the first antenna 110 is positioned closer to the ground 130 than the second antenna 120 is. In the example of FIG. 6, the first antenna 110 is disposed in a space between the second linear element 121 and the side 130a.

As described above, the first antenna 110 and the second antenna 120 have a low correlation in the vibration direction of the electric field, and thus are unlikely to interfere with each other. Therefore, as illustrated in FIG. 6, the first antenna 110 and the second antenna 120 can be disposed closer to each other.

With the first antenna 110 and the second antenna 120 disposed closer to each other, it is possible to further miniaturize the antenna device 100A.

The first antenna 110 and the second antenna 120 are disposed on identical side 130a, for example. The first antenna 110 and the second antenna 120 can be disposed such that a distance between the two antennas becomes a distance according to a shape of the ground 130 such as a length of side 130a, or other elements (not illustrated), for example.

In this manner, the first antenna 110 and the second antenna 120 can be disposed close to each other, making it possible for the antenna devices 100 and 100A of the present disclosure to further improve the degree of freedom in the layout of the first antenna 110 and the second antenna 120.

Although FIG. 6 illustrates a case where the entire portion of the first antenna 110 is located between at least a part of the second antenna 120 and the side 130a of the ground 130, the layout of the first antenna 110 is not limited to this. At least a part of the first antenna 110 may be located between at least a part of the second antenna 120 and the side 130a of the ground 130.

### 3. Third Embodiment

Although the antenna devices 100 and 100A according to the first and the second embodiments above has been described as a case where the second antenna 120 is a monopole antenna, the second antenna 120 is not limited to a monopole antenna. The other configuration is allowable as long as the vibration direction of the electric field generated by the second antenna 120 has a low correlation with the vibration direction of the electric field generated by the first antenna 110.

Other examples of the second antenna 120 will be described with reference to FIGS. 7 to 9.

FIG. 7 is a diagram illustrating an example of a schematic configuration of an antenna device 100B according to a third embodiment of the present disclosure. FIG. 7 illustrates a case where the second antenna 120B is a loop antenna.

As illustrated in FIG. 7, the second antenna 120B includes a second linear element 121B and a feed point 122B. Each end of the second linear element 121B is connected to the side 130a of the ground 130. The feed point 122B is disposed at one end of the second linear element 121B.

Here, the second antenna 120B is an antenna generally referred to as a loop antenna. That is, the length of the second antenna 120B, in other words, the length of the second linear element 121B is about one wavelength of the operating frequency of the second antenna 120B.

The first antenna 110B has the same configuration as the first antenna 110 in FIG. 6 except that a first linear element 111B is bent at two positions.

As illustrated in FIG. 7, the first antenna 110B is a quadrangular small loop antenna. In this manner, the shape of the first antennas 110, 110B of the present disclosure is not limited to the triangular shape or the quadrangular shape, and may be partially curved or polygonal.

The first antenna 110B is disposed between the second antenna 120B and the side 130a of the ground 130. That is, the first antenna 110B is disposed inside the second antenna 120B being a loop antenna.

Note that the layout of the first antenna 110B is not limited to the example of FIG. 7. For example, similarly to FIG. 1, the first antenna 110B may be disposed next to the second antenna 120B.

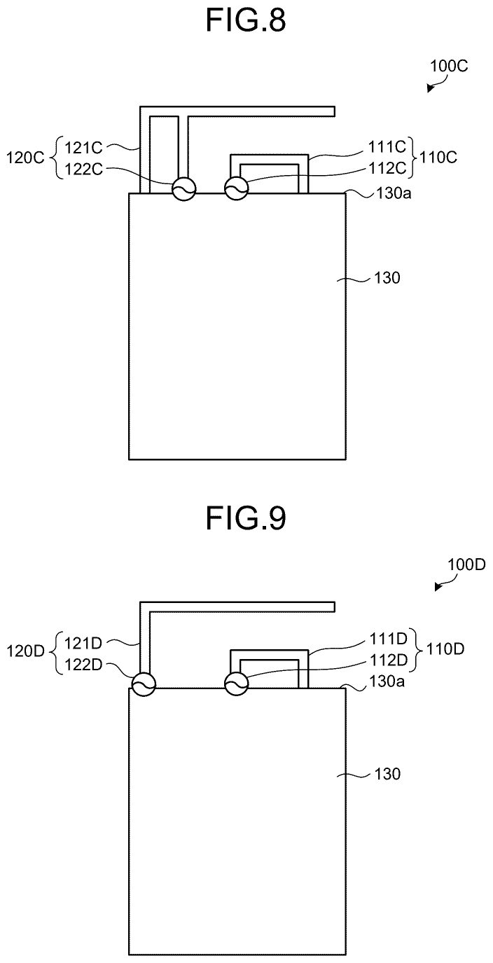

FIG. 8 is a diagram illustrating an example of a schematic configuration of an antenna device 100C according to the third embodiment of the present disclosure. FIG. 8 illustrates a case where second antenna 120C is an inverted-F antenna. The antenna device 100 C illustrated in FIG. 8 has the same configuration as the antenna device 100B illustrated in FIG. 7 except that the second antenna 120C is an inverted-F antenna.

As illustrated in FIG. 8, the second antenna 120C includes a second linear element 121C and a feed point 122C. As described above, the second antenna 120C is an inverted-F antenna.

The first antenna 110C is disposed between the second antenna 120C and the side 130a of the ground 130. Note that the layout of the first antenna 110C is not limited to the example of FIG. 8. For example, similarly to FIG. 1, the first antenna 110C may be disposed next to the second antenna 120C.

FIG. 9 is a diagram illustrating an example of a schematic configuration of an antenna device 100D according to the third embodiment of the present disclosure. FIG. 9 illustrates a case where the second antenna 120D is an inverted-L antenna. The antenna device 100D illustrated in FIG. 9 has the same configuration as the antenna device 100C illustrated in FIG. 8 except that the second antenna 120D is an inverted-L antenna.

As illustrated in FIG. 9, the second antenna 120D includes a second linear element 121D and a feed point 122D. As described above, the second antenna 120D is an inverted-L antenna.

The first antenna 110D is disposed between the second antenna 120D and a side 130a of the ground 130. Note that the layout of the first antenna 110D is not limited to the example of FIG. 9. For example, similarly to FIG. 1, the first antenna 110D may be disposed next to the second antenna 120D.

### 4. Fourth Embodiment

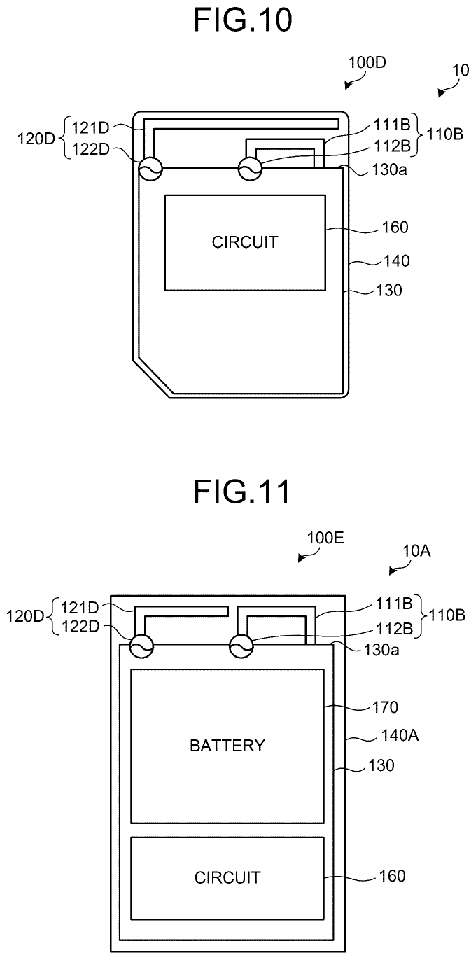

FIG. 10 is a diagram illustrating an example of a schematic configuration of a wireless device 10 according to a fourth embodiment of the present disclosure. FIG. 10 illustrates an example in which the antenna device 100D illustrated in FIG. 9 is mounted on an SD card module.

As illustrated in FIG. 10, the wireless device 10 includes first antenna 110B, a second antenna 120D, a ground 130, a housing 140, and a circuit 160.

The ground 130 has, for example, a polygonal shape corresponding to the shape of the housing 140 of the SD card module. The circuit 160 is disposed on the ground 130, for example. The circuit 160 is, for example, a wireless circuit, and performs wireless communication with other wireless devices (not illustrated) via the first antenna 110B and the second antenna 120D.

As described above, the first antenna 110B and the second antenna 120D can simultaneously transmit and receive signals of the same frequency. Therefore, the circuit 160 can perform MIMO communication with another wireless device (not illustrated).

For example, the wireless device 10 is inserted into an SD card slot provided on an information processing device (not illustrated) such as a personal computer (PC) or an imaging device, and functions as a wireless device of the information processing device.

Here, the SD card slot is formed with metal, for example. Therefore, the SD card module inserted into the SD card slot has its partial region (for example, a region excluding the ground 130 in FIG. 10; hereinafter, also referred to as a non-metal region) exposed without being covered with metal, but its major region (for example, a region where the ground 130 in FIG. 10 is disposed; hereinafter, also referred to as a metal region) is covered with metal. Therefore, in a case where the antenna device is mounted on the SD card module, it is necessary to locate the antenna in the partial region (non-metal region) not covered with metal.

This non-metal region not covered with metal has a small footprint, and it has been difficult, in the conventional antenna device, to dispose a plurality of antennas in the region.

In contrast, in the antenna device 100D according to the proposed technology of the present disclosure, the first antenna 110B and the second antenna 120D can be disposed close to each other. This can achieve further miniaturization of the antenna device 100D, making it possible for the wireless device 10 to dispose the plurality of antennas (first antenna 110B and the second antenna 120D) in the non-metal region.

As described above, the antenna device 100D can be used for MIMO communication. Accordingly, the wireless device 10 with the antenna device 100D can perform 2×2 MIMO communication, for example. Therefore, by inserting the wireless device 10 into the SD card slot, for example, an information processing device (not illustrated) with no MIMO communication function can perform MIMO communication.

Although an example in which the antenna device 100D is mounted on the wireless device 10 has been described here, the antenna device mounted on the wireless device 10 is not limited to the antenna device 100D. At least one of the antenna devices 100, and 100A to 100D, can be mounted on the wireless device 10.

### 5. Fifth Embodiment

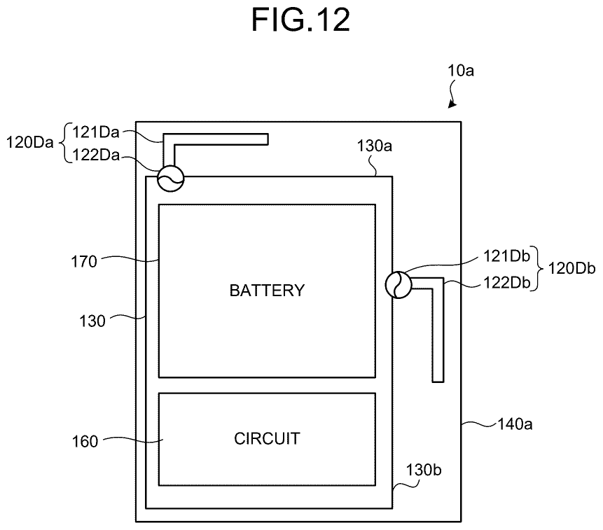

FIG. 11 is a diagram illustrating an example of a schematic configuration of a wireless device 10A according to a fifth embodiment of the present disclosure. FIG. 11 illustrates an example in a case where an antenna device 100E is mounted on an information processing device such as a smartphone.

The wireless device 10A illustrated in FIG. 11 includes the antenna device 100E, a housing 140A, a circuit 160, and a battery 170.

The antenna device 100E includes a first antenna 110B and a second antenna 120D. The antenna device 100E has the same configuration as the antenna device 100D illustrated in FIG. 9 except for the layout of the first antenna 110B.

For example, the first antenna 110B and the second antenna 120D are disposed on the side 130a being a short side of the ground 130.

The ground 130 also functions as a ground of the wireless device 10A, for example. The circuit 160 and the battery 170 are disposed on the ground 130.

The circuit 160 is, for example, a wireless circuit, and performs wireless communication with other wireless devices (not illustrated) via the first antenna 110B and the second antenna 120D. The battery 170 supplies power to the circuit 160 and other modules (not illustrated).

As described above, the first antenna 110B and the second antenna 120D can simultaneously transmit and receive signals of the same frequency. Therefore, the circuit 160 can perform MIMO communication with another wireless device (not illustrated).

For example, it is assumed that the wireless device 10A performs 2×2 MIMO communication at the time of reception. In this case, the wireless device 10A transmits a signal using one antenna (for example, the second antenna 120D), for example. The wireless device 10A simultaneously receives signals using both the first antenna 110B and the second antenna 120D, for example.

As described above, in the wireless device 10A, both the first antenna 110B and the second antenna 120D are disposed on the side 130a being a short side of the ground 130. This makes it possible to miniaturize the wireless device 10A. This point will be described with reference to FIG. 12.

Here, FIG. 12 is a diagram illustrating an example of a schematic configuration of a wireless device 10a. The wireless device 10a illustrated in FIG. 12 includes a plurality of antennas 120Da and 120Db, a ground 130, a housing 140a, a circuit 160, and a battery 170.

The plurality of antennas 120Da and 120Db are inverted-L antennas. The antenna 120Da is disposed on a side 130a of the ground 130. Antenna 120Db is disposed on a side 130b of the ground 130. The side 130b is a side orthogonal to the side 130a.

The wireless device 10a disposes antennas 120Da and 120Db respectively on sides 130a and 130b which are orthogonal to each other. This makes it possible for the wireless device 10a to ensure the isolation of the antennas 120Da and 120Db from each other. This enables the wireless device 10a to also perform MIMO communication similarly to the wireless device 10A in FIG. 11.

However, in order to ensure isolation of the antennas 120Da and 120Db from each other, the wireless device 10a disposes the antennas 120Da and 120Db on different sides 130a and 130b, respectively. This causes enlargement of the wireless device 10a.

In contrast, the wireless device 10A according to the present embodiment disposes the first antenna 110B and the second antenna 120D on the side 130a. This makes it possible to further miniaturize the wireless device 10A while implementing MIMO communication.

Furthermore, in a case where the wireless device 10A is a device used by being held by a user's hand, such as a smartphone, by disposing the first antenna 110B and the second antenna 120D on the side 130a, it is possible to suppress the decrease of gain of the antenna device 100E.

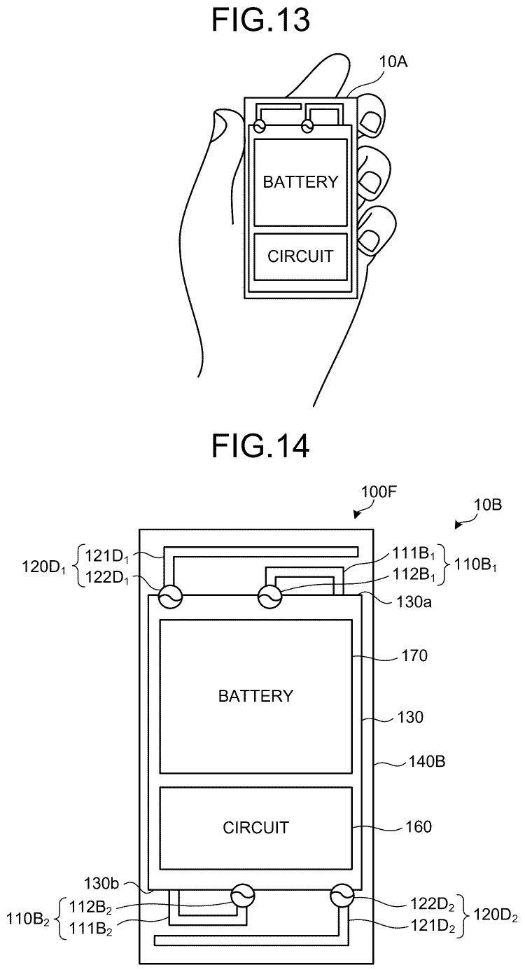

FIG. 13 is a diagram illustrating a use example of the wireless device 10A according to the fifth embodiment of the present disclosure. As illustrated in FIG. 13, in a case where the user holds and uses the rectangular wireless device 10A in hand, the user holds the long side of the wireless device 10A.

Therefore, for example, disposing an antenna (for example, the antenna 120Db) on a long side (for example, the side 130b) of the ground 130 as in the wireless device 10a (refer to FIG. 12) might deteriorate the gain of the antenna due to the hand of the user.

In contrast, the wireless device 10A according to the present embodiment disposes the first antenna 110B and the second antenna 120D on the side 130a, which is a short side of the ground 130. This makes the first antenna 110B and the second antenna 120D less affected by the hand of the user. With this configuration, the wireless device 10A can suppress a decrease in the gain of the antenna device 100E.

In the present embodiment, The wireless device 10A includes the second antenna 120D that is an inverted-L antenna. However, the second antenna 120D is not limited to the inverted-L antenna. The second antenna 120D may be, for example, a monopole antenna, a loop antenna, an inverted-F antenna, or the like.

In the present embodiment, the first antenna 110B is disposed next to the second antenna 120D. However, the disposition of the first antenna 110B is not limited to this.

For example, the first antenna 110B may be disposed between the second antenna 120D and ground 130 (refer to FIG. 9).

### 6. Sixth Embodiment

FIG. 14 is a diagram illustrating an example of a schematic configuration of a wireless device 10B according to a sixth embodiment of the present disclosure. FIG. 14 illustrates an example in a case where an antenna device 100F is mounted on an information processing device such as a smartphone.

The wireless device 10B illustrated in FIG. 14 includes the antenna device 100F, a housing 140B, a circuit 160, and a battery 170.

The antenna device 100F includes first antennas 110B₁ and 110B₂ and second antennas 120D₁ and 120D₂. The first antenna 110B₁ and the second antenna 120D₁ have the same configuration as the first antenna 110B and the second antenna 120D illustrated in FIG. 9. The first antenna 110B₂ and the second antenna 120D₂ have the same configuration as the first antenna 110B and the second antenna 120D illustrated in FIG. 9 except that the first antenna 110B₂ and the second antenna 120D₂ are disposed on the side 130c.

As illustrated in FIG. 14, the antenna device 100F according to the present embodiment includes the first antennas 110B₁ and 110B₂ and the second antennas 120D₁ and 120D₂ disposed on the sides 130a and 130c which are short sides of the ground 130.

The ground 130 also functions as a ground of the wireless device 10B, for example. The circuit 160 and the battery 170 are disposed on the ground 130.

The circuit 160 is, for example, a wireless circuit, and performs wireless communication with other wireless devices (not illustrated) via the first antenna 110B and the second antenna 120D. The battery 170 supplies power to the circuit 160 and other modules (not illustrated).

The first antennas 110B₁ and 110B₂ and the second antennas 120D₁ and 120D₂ can simultaneously transmit and receive signals of the same frequency. Therefore, the circuit 160 can perform MIMO communication with another wireless device (not illustrated).

For example, it is assumed that the wireless device 10B performs 4×4 MIMO communication at the time of reception. In this case, the wireless device 10B transmits a signal using one antenna (for example, the second antenna 120D₂), for example.

For example, the wireless device 10B simultaneously receives signals using all of the first antennas 110B₁ and 110B₂ and the second antennas 120D₁ and 120D₂.

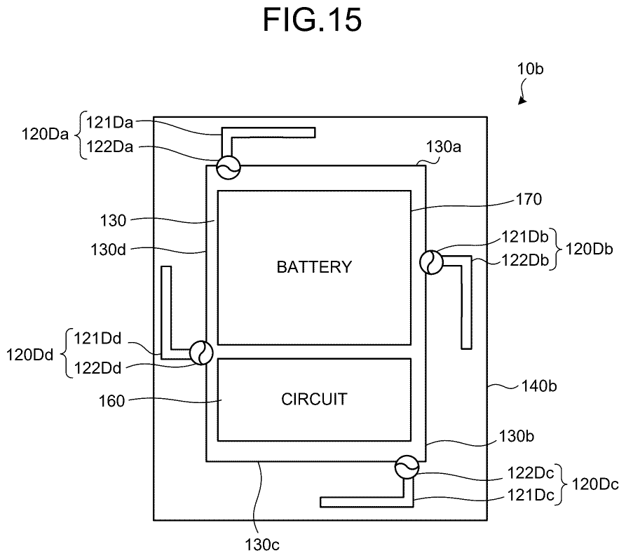

As described above, the wireless device 10B disposes the first antennas 110B₁ and 110B₂ and the second antennas 120D₁ and 120D₂ on the sides 130a and 130c being short sides of the ground 130. This makes it possible to miniaturize the wireless device 10B. This point will be described with reference to FIG. 15.

FIG. 15 is a diagram illustrating an example of a schematic configuration of a wireless device 10b. The wireless device 10b illustrated in FIG. 15 includes a plurality of antennas 120Da to 120Dd, a ground 130, a housing 140b, a circuit 160, and a battery 170.

The plurality of antennas 120Da to 120Dd are inverted-L antennas. The antenna 120Da is disposed on a side 130a of the ground 130. Antenna 120Db is disposed on a side 130b of the ground 130. The side 130b is a side orthogonal to the side 130a.

The antenna 120Dc is disposed on a side 130c of the ground 130. The side 130c is a side facing the side 130a. The antenna 120Dd is disposed on a side 130d of the ground 130. The side 130d is a side facing the side 130b.

The wireless device 10a disposes antennas 120Da and 120Db respectively on sides 130a and 130b which are orthogonal to each other. This makes it possible for the wireless device 10a to ensure the isolation of the antennas 120Da and 120Db from each other. This enables the wireless device 10a to also perform MIMO communication similarly to the wireless device 10A in FIG. 11.

However, in order to ensure isolation of the antennas 120Da to 120Dd, the wireless device 10a disposes the antennas 120Da to 120Dd on different sides 130a to 130d, respectively. This causes enlargement of the wireless device 10b.

In contrast, the wireless device 10B according to the present embodiment disposes the first antenna 110B₁ and 110B₂ and the second antenna 120D₁ and 120D₂ on the side 130a and 130c, which are short sides. This makes it possible to further miniaturize the wireless device 10B while implementing MIMO communication.

In addition, it is assumed that the wireless device 10B is a device that is used by a user by being held in a hand, such as a smartphone. In this case, by disposing the first antennas 110B₁ and 110B₂ and the second antennas 120D₁ and 120D₂ on the sides 130a and 130c which are short sides, the wireless device 10B can suppress a decrease in the gain of the antenna device 100F similarly to the wireless device 10A.

In the present embodiment, the wireless device 10B includes the second antennas 120D₁ and 120D₂ which are inverted-L antennas. However, the second antennas 120D₁ and 120D₂ are not limited to the inverted-L antennas. The second antennas 120D₁ and 120D₂ may each be, for example, a monopole antenna, a loop antenna, an inverted-F antenna, or the like.

In the present embodiment, the first antenna 110B₁ is disposed between the second antenna 120D₁ and ground 130, while the first antenna 110B₂ is disposed between the second antenna 120D₂ and the ground 130. However, the layout of the first antennas 110B₁ and 110B₂ is not limited thereto. For example, the first antenna 110B₁ may be disposed next to the second antenna 120D₁, and the first antenna 110B₂ may be disposed next to the second antenna 120D₂ (refer to FIG. 11).

Note that, in the example illustrated in FIG. 14, the first antenna 110B₁ is disposed between the second antenna 120D₁ and ground 130. This configuration allows the wireless device 10B to make the element lengths of the first antenna 110B₁ and the second antenna 120D₁ longer than the case that the first antenna 110B₁ is disposed next to the second antenna 120D₁. The longer the antenna length, the lower the operating frequency of the antenna. By increasing the element lengths of the first antenna 110B₁ and the second antenna 120D₁, the wireless device 10B can perform transmission and reception in a lower frequency band.

### 7. Seventh Embodiment

The fifth and sixth embodiments have described the case where the antenna devices 100E and 100F are mounted on an information processing device such as a smartphone. However, the device on which the antenna devices 100E and 100F are mounted is not limited to the information processing device. For example, the antenna device 100E may be mounted on a peripheral device of the information processing device.

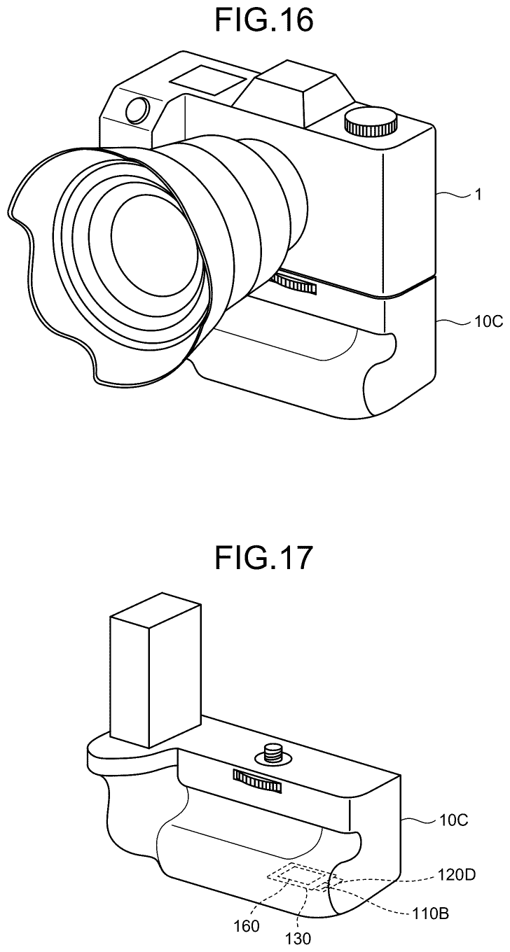

FIGS. 16 and 17 are diagrams illustrating an example of a schematic configuration of a peripheral device 10C according to a seventh embodiment of the present disclosure. FIG. 16 illustrates a peripheral device 10C (for example, an add-on grip of an imaging device 1) used by being attached to the imaging device 1.

As illustrated in FIG. 17, the peripheral device 10C includes an antenna device 100E and a circuit 160. The antenna device 100E includes a first antenna 110B, a second antenna 120D, and a ground 130. The circuit 160 is disposed on the ground 130 and performs wireless communication via, for example, the first antenna 110B and the second antenna 120D.

By including the antenna device 100E and the circuit 160, the peripheral device 10C functions as a wireless device. The communication partner of the peripheral device 10C may be the imaging device 1 or another device (not illustrated).

For example, in a case where the peripheral device 10C includes a reception portion (not illustrated) that receives an instruction from the user such as a button, the peripheral device 10C can notify the imaging device 1 of the instruction from the user via the antenna device 100E.

Alternatively, in a case where the peripheral device 10C performs wireless communication with another device (not illustrated), the peripheral device 10C may transmit an image captured by the imaging device 1 to another device, for example. The peripheral device 10C can transfer an image acquired from the imaging device 1 to another device via another communication channel, for example. The other communication channel for acquiring an image may be a wired communication channel or a wireless communication channel.

As described above, the antenna device 100E may be used in MIMO communication. Therefore, the peripheral device 10C can transmit and receive signals such as images by MIMO communication using the antenna device 100E. This makes it possible for the peripheral device 10C to communicate with the imaging device 1 and other devices at a higher speed.

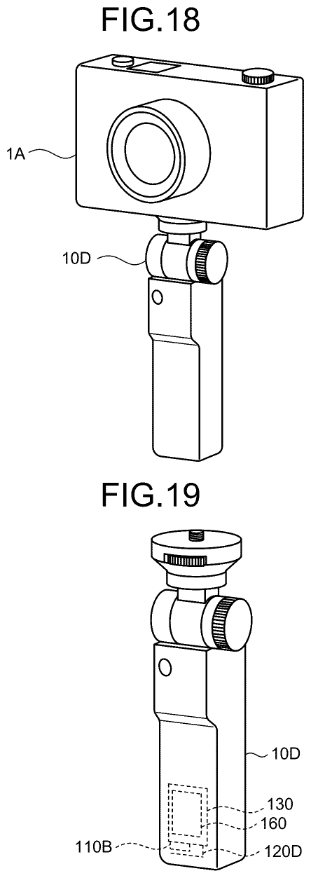

FIGS. 18 and 19 are diagrams illustrating an example of a schematic configuration of a peripheral device 10D according to the seventh embodiment of the present disclosure. FIG. 18 illustrates the peripheral device 10D (for example, an add-on grip of an imaging device 1) used by being attached to the imaging device 1. As illustrated in FIG. 19, the peripheral device 10D includes the antenna device 100E and the circuit 160.

The function and configuration of the peripheral device 10D are the same as those of the peripheral device 10C illustrated in FIG. 17, for example, except for the shape of the peripheral device 10D.

Here, the peripheral devices 10C and 10D include the antenna device 100E, but the antenna device included in the peripheral device 10C is not limited thereto. For example, the peripheral devices 10C and 10D may include the antenna devices 100, 100A to 100D, or 100F.

Furthermore, the peripheral devices 10C and 10D may include a plurality of antenna devices 100. The layout of the antenna device 100E in the peripheral devices 10C and 10D illustrated in FIG. 17 or 19 is an example. The antenna device 100E can be disposed at any position of the peripheral devices 10C and 10D.

### 8. Summary

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

The effects described in individual embodiments of the present specification are merely examples, and thus, there may be other effects, not limited to the exemplified effects.

Note that the present technology can also have the following configurations.
(1)
An antenna device comprising:
a first antenna provided on one side of a ground and having a length shorter than one wavelength of an operating frequency; and
a second antenna provided on the one side, the second antenna being an antenna different from the first antenna.
(2)
The antenna device according to (1), wherein the one side is a short side of the ground having a rectangular shape.
(3)
The antenna device according to (1) or (2), wherein the first antenna and the second antenna operate in a same frequency band.
(4)
The antenna device according to any one of (1) to (3), wherein the first antenna is located between at least a part of the second antenna and the one side.
(5)
The antenna device according to any one of (1) to (4), wherein the second antenna is any of a monopole antenna, an inverted-F antenna, an inverted-L antenna, and a loop antenna having a length of one wavelength of the operating frequency.
(6)
A wireless device comprising:
an antenna device; and
a wireless circuit that performs wireless communication using the antenna device,
wherein the antenna device includes:
a first antenna provided on one side of a ground and having a length shorter than one wavelength of an operating frequency; and
a second antenna provided on the one side, the second antenna being an antenna different from the first antenna.
(7)
The wireless device according to (6), wherein the wireless circuit performs MIMO communication using the first antenna and the second antenna.

### REFERENCE SIGNS LIST

1 IMAGING DEVICE
10, 10A, 10B WIRELESS DEVICE
10C, 10D PERIPHERAL DEVICE
100, 100A to 100F ANTENNA DEVICE
110, 110B to 110D FIRST ANTENNA
120, 120B to 120D SECOND ANTENNA
130 GROUND

What is claimed is:

1. An antenna device comprising:
a first antenna provided on one side of a ground and having a length shorter than one wavelength of an operating frequency; and
a second antenna provided on the one side, the second antenna being an antenna different from the first antenna.

2. The antenna device according to claim 1, wherein the one side is a short side of the ground having a rectangular shape.

3. The antenna device according to claim 1, wherein the first antenna and the second antenna operate in a same frequency band.

4. The antenna device according to claim 1, wherein the first antenna is located between at least a part of the second antenna and the one side.

5. The antenna device according to claim 1, wherein the second antenna is any of a monopole antenna, an inverted-F antenna, an inverted-L antenna, and a loop antenna having a length of one wavelength of the operating frequency.

6. A wireless device comprising:
an antenna device; and
a wireless circuit that performs wireless communication using the antenna device,
wherein the antenna device includes:
a first antenna provided on one side of a ground and having a length shorter than one wavelength of an operating frequency; and
a second antenna provided on the one side, the second antenna being an antenna different from the first antenna.

7. The wireless device according to claim 6, wherein the wireless circuit performs MIMO communication using the first antenna and the second antenna.
